(19) United States
(12) Patent Application Publication
(10) Pub. No.: US 2016/0316516 A1
(43) Pub. Date: Oct. 27, 2016

(54) HEATING DEVICE FOR HEATING LIQUIDS, EVAPORATOR FOR AN ELECTRIC COOKING APPLIANCE AND METHOD FOR OPERATING A HEATING DEVICE

(71) Applicant: E.G.O. Elektro-Geraetebau GmbH, Oberderdingen (DE)

(72) Inventors: Holger Koebrich, Kraichtal-Gochsheim (DE); Roland Muehlnikel, Bretten (DE); Michael Tafferner, Malsch (DE); Manuel Schmieder, Oberderdingen (DE); Bernd Robin, Kraichtal (DE); Matthias Mandl, Bretten (DE); Alfred Suss, Bretten (DE); Sebastian Eigl, Bretten (DE)

(21) Appl. No.: 15/134,060

(22) Filed: Apr. 20, 2016

(30) Foreign Application Priority Data
Apr. 21, 2015 (DE) 10 2015 207 253.3

(51) Int. Cl. H05B 1/02; A47J 27/00; A47J 27/16; H05B 3/00; H05B 3/06

(52) U.S. Cl. CPC H05B 1/0269; H05B 3/0014; H05B 3/06; A47J 27/16; A47J 27/004; A47J 2202/00

(57) ABSTRACT

A heating device for evaporating liquids for an electric cooking appliance, having a container for the liquid, which container is higher than it is wide, wherein heating elements are distributed over the surface area of the outside of a lateral container wall and a plurality of temperature sensors are provided. There are at least three separate and separately operable heating circuits, wherein each heating circuit has at least one heating element. The plurality of temperature sensors are provided in the form of two types, wherein a first type are discrete components which are mounted on the outside of the container wall, and wherein a second type is fitted in the form of a surface-area coating to the outer face of the container wall.

### CROSS-REFERENCE TO RELATED APPLICATIONS

This application claims priority to German Application No. 10 2015 207 253.3, filed Apr. 21, 2015, the contents of which are hereby incorporated herein in its entirety by reference.

### TECHNOLOGICAL FIELD

The invention relates to a heating device for heating liquids and/or for evaporating liquids for an electric cooking appliance, in particular for a steam cooker, and to an evaporator for an electric cooking appliance having a heating device of this kind, and to a method for operating a heating device of this kind and, respectively, for operating a corresponding electric cooking appliance.

### BACKGROUND

WO 02/12790 A1 discloses a cooking appliance involving steam generation by means of a heating device which has a steam generation container in the form of a vertical pipe. A flat heating element is arranged on the outside of the steam generation container. Water is supplied to the steam generation container from below, while the generated steam can escape at the top and is used for the purpose of steam cooking in the cooking appliance.

### BRIEF SUMMARY

The invention is based on the object of providing a heating device of the kind mentioned in the introductory part and an evaporator for an electric cooking appliance and a method for operating a heating device of this kind and, respectively, an evaporator, with which heating device, evaporator and method problems of the prior art can be solved and, in particular, which make it possible for liquids to be evaporated quickly, in an energy-efficient manner and at the same time reliably and without susceptibility to faults. The aim is therefore to be able to operate an evaporator and an electric cooking appliance reliably at a high power.

This object is achieved by a heating device, an evaporator for an electric cooking appliance or a corresponding electric cooking appliance, and a method. Advantageous and preferred refinements of the invention are the subject matter of the further claims and will be explained in greater detail in the text which follows. In the text, some of the features are described only for the heating device, only for the evaporator or the electric cooking appliance or only for the method. However, irrespective of this, it should be possible for the features to be able to apply independently both to the heating device and to the evaporator or the electric cooking appliance and also to the method. The wording of the claims is hereby incorporated in the description by express reference.

The heating device, which is used for heating liquids and/or for evaporating liquids, in particular water, for an electric cooking appliance, in particular an evaporator or steam cooking appliance, has the following features. It has a container for the liquid which is to be evaporated, wherein the container is arranged upright or its height is greater than its width. The container is advantageously higher than it is wide, particularly advantageously twice to five times as high as it is wide, but it can also be wider than it is high. In principle, the container can have any desired cross section, advantageously a round or circular cross section. The container can preferably be of cylindrical design, in particular in the form of a round cylindrical pipe. The diameter can lie between 3 cm and 15 cm and the height can correspond to the diameter.

Heating elements are arranged, in a manner distributed over the surface area, on an outer face of a lateral container wall which forms the casing of the container. The heating elements should cover a large portion of the outer face, for example between 60% and 90%. The heating elements can be of different design, and are advantageously surface-area heating elements, in particular film-type heating elements or thick-film heating elements. Heating elements of this kind are known from US 2014/0029928 A1 for example. The heating elements are divided into at least three separate and/or separately operable heating circuits. Each of these heating circuits has at least one heating element. The definition of a heating element comprises a section of an electrical resistor which becomes hot or heats up when operated with current flow. In this case, a heating element can comprise, in particular, a corresponding resistor material and run between two connections or contact-connection means. A heating circuit is defined in that the heating elements which make up the heating circuit can only be operated, that is to say switched on and switched off, together. The same current advantageously flows through the heating elements of a common heating circuit, that is to say the heating elements are connected in series.

A heating circuit advantageously has a plurality of heating elements which are, however, particularly advantageously connected in series. Furthermore, a plurality of temperature sensors are provided on the outer face since temperature detection in a heating device or an evaporator is important both for regular operation and for identifying problems or faults during operation. The temperature sensors are provided in the form of at least two types, that is at least two types of temperature sensors are provided.

The first type of temperature sensors are discrete components which are mounted on the outer face of the container wall, for example are SMD components. In this case, the temperature sensors are mounted and electrical contact is made with the temperature sensors and the temperature sensors are fastened, for example, on corresponding contact fields. A second type of temperature sensors are advantageously fitted to the outer face of the container wall in the form of a surface-area coating or in the form of a coating which covers a surface area. Therefore, the difference in comparison to the temperature sensors of the first type is that it is also possible to monitor a temperature or hot spots virtually over the surface area owing to the surface-area coating of a certain size or extent, in particular of a significant proportion of the surface area of the outer face of the container wall. This will be explained yet further in the text which follows.

A wide adjustment range for heating or the introduced heating output at the heating device can be achieved by dividing the heating for the heating device into a plurality of separate or separately operable heating circuits. Therefore, under certain circumstances, a heating circuit can also be switched off, for example when it is not required or exhibits a malfunction. It is also possible to, as it were, further subdivide a heating circuit into two or more partial heating circuits, each of which has its own heating elements. The heating circuit can be subdivided into an upper partial heating circuit and a lower partial heating circuit, alternatively into partial heating circuits which are interleaved or engage one into the other in a meandering manner. Each of the partial heating circuits can then be operated separately, for example by a connection in the form of an intermediate tap, and therefore they must not be operated together. At least one partial heating circuit should be designed such that it can be switched off. The topmost heating circuit and/or the middle heating circuit are/is advantageously designed in this way.

Both the operation of the heating device and also the state of the heating device, in particular in respect of failures or the formation of limescale on the inner face of the container wall, can be monitored by the plurality of temperature sensors in a corresponding plurality of regions. This is always an important issue for heating devices for liquids and evaporators.

In one refinement of the invention, the temperature sensors of the first type are NTC sensors, as are known in principle. The temperature sensors of the first type can likewise advantageously be in the form of SMD components and be fitted to the outer face in corresponding contact fields. A temperature sensor of the first type of this kind measures the temperature in a physically very closely limited region around it, for example 1 cm or less in the case of SMD components. If a temperature sensor of the first type of this kind is fitted to the container outer face at a level at which there is always water during operation, the temperature sensor may detect the water temperature approximately with slight corruption owing to a physical proximity to a heating element on the one hand and owing to the separation from the liquid, which is to be heated, by the container wall on the other hand. Therefore, relatively large or large surface-area temperature monitoring operations are unlikely to be able to be effectively carried out.

In an advantageous refinement of the invention, at least one temperature sensor of the first type, particularly advantageously precisely one single temperature sensor of the first type, is provided for each heating circuit. A temperature sensor of the first type of this kind can be provided in the region of and along a longitudinal axis of the container vertically level with the respective heating circuit, that is to say provided, as it were, close to a heating circuit and therefore associated therewith. Provision can be made for in each case precisely one temperature sensor of the first type to be provided for at least the lowermost heating circuit, advantageously for the two lowermost heating circuits. The temperature sensor can then, in turn, be provided in each case in the lower region of the heating circuit, for example level with the lowermost heating element of the heating circuit. Therefore, the temperature of a liquid with a filling level which extends from the bottom straight to the heating circuit can be detected.

A distance between a temperature sensor of the first type of this kind from a closest heating element can lie between twice and twenty times, advantageously between five times and ten times, the thickness of the container wall. Therefore, the distance is not particularly large, it can also be one to three times the maximum longitudinal extent of the temperature sensor. Therefore, the temperature sensor of the first type can detect the temperature of the container wall in its closest region and therefore the temperature of a liquid inside the container in this region substantially without being influenced by a closest heating element. If the liquid is water and the temperature is clearly above 100° C., it is possible to easily conclude, as will be discussed further below, that there is no longer any water in the region of the temperature sensor, this possibly then leading to the heating circuit which is associated with this temperature sensor of the first type being switched off.

For the topmost heating circuit, provision can be made for the associated temperature sensor of the first type to be arranged in the upper region of the topmost heating circuit, advantageously almost at the very top. The distance from the heating elements can substantially be, under certain circumstances, somewhat smaller, as described above.

For the temperature sensor of the second type, a dielectric insulation layer can be fitted on the outer face of the container wall, the heating elements of a heating circuit being fitted over the dielectric insulation layer, in a refinement of the invention. In turn, a covering layer can be provided over the heating element, it being possible for the covering layer to also serve for insulation purposes and to prevent corrosion. Furthermore, a measurement electrode is provided on the insulation layer or advantageously on a conductive surface therebeneath which serves as an electrical connection to the insulation layer. In the case of a metallic container, the outer face of the metallic container is the conductive surface. A measuring device which forms part of the heating device and is advantageously integrated in the control system of the heating device is connected both to the measurement electrode and also to the heating elements or to a respective heating circuit by means of the dielectric insulation layer, the heating elements serving as the other electrode. In this case, the measuring device is designed to detect a current flow between the heating elements or the heating circuit and the measurement electrode. The current flow can, in turn, be used as a measure of a change in temperature at the heating circuit or at the container in the region close to the heating circuit.

Temperature detection of this type in the case of heating elements, which are distributed over the surface area, by means of a dielectric insulation layer is known from DE 102013200277 A1 and WO 2007/136268 A1 to which explicit reference is made, in particular in respect of the design of the dielectric insulation layer. In the documents, the so-called discharge current is measured, the discharge current flowing across or through the insulation layer to the heating elements of the heating circuit. As the temperature increases, the insulation layer becomes current-carrying or its electrical resistance becomes lower since this property is highly temperature-dependent. Therefore, in the case of local overheating or locally closely limited overheating, for example to 200° C. to 250° C., this can be detected within the relatively large surface area of an overall heating circuit since, in this range of overheating, the electrical resistance of the insulation layer drops considerably and therefore the current across the insulation layer to the heating elements increases all at once. Although the point at which this local overheating occurs cannot be detected, this is not required either since local overheating of this kind is judged as a fault in all cases and therefore can lead to the corresponding heating circuit or even the entire heating device being switched off. Therefore, the temperature sensors of the second type can be used to monitor a large region for severe excessive increases in temperature which, however, do not have to take place over a large surface area but can already be detected in a relatively point by point manner.

The dielectric insulation layer is advantageously fitted directly on the outer face of the container wall and covers a large portion of the entire surface of the outer face of the container wall. In particular, the insulation layer covers at least 90% of the surface of the outer face, wherein the insulation layer is advantageously a single continuous dielectric insulation layer beneath all of the heating elements. Dividing the individual heating circuits from one another with respective separation means is not necessary since it is possible to detect what occurs in the region of this heating circuit by means of contact being made with the corresponding heating circuit as a kind of electrode.

In a refinement of the invention, the measurement electrode and the heating elements run in different layers. The insulation layer and/or a covering layer can advantageously be located therebetween. A measurement electrode of this kind can be formed over the surface area and substantially cover the heating elements, so that the heating elements themselves do not have to be used as measurement electrode and better separation is possible. A first measurement electrode can simply advantageously be fitted directly to the outer face of the lateral container wall if the outer face of the lateral container wall is composed of metal. Therefore, the first measurement electrode is distributed virtually continuously over all of the heating circuits. However, subdivision of the temperature detection between the regions of the individual heating circuits takes place by making contact with the heating circuits themselves.

In a further refinement of the invention, a further additional insulation layer can be fitted on the insulation layer. The further additional insulation layer can advantageously be a so-called intermediate glass layer. In this case, the heating elements can preferably be fitted on the additional insulation layer. As a result, the effect for temperature measurement can be intensified.

At least one temperature sensor of the second type, preferably precisely one temperature sensor of the second type, is advantageously provided for each heating circuit. The temperature sensor in this case covers at least 50%, in particular 90% to 100%, of the surface area of the heating elements of the associated heating circuit. In this case, the entire surface area of the heating circuit can be monitored for local increases in temperature, as has been described above.

In an advantageous refinement of the invention, all of the heating circuits can have a similarly high electrical power, particularly advantageously the same electrical power. The electrical power can lie in the region of a few kilowatts, for example approximately 3 kW for each heating circuit.

Provision can be made, in the vertical extent of the container, for each heating circuit to be at a distance from the other heating circuits. Therefore, each heating circuit covers a particular vertical region of the outer face of the container wall, and therefore the heating circuits do not overlap in the vertical direction. At least the two lowermost vertical regions and therefore also heating circuits are preferably of equal height. In particular, the two lowermost heating circuits are of identical design in respect of their heating elements and/or arrangement in this case. This can also apply for the arrangement of a temperature sensor of the first type and/or of the second type on the respective heating circuit. The uppermost vertical region or heating circuit can be somewhat higher, for example at most 20% higher.

The vertical distance between the uppermost heating element of the uppermost heating circuit and the adjacent heating element which is situated below it can be greater than the distance between the adjacent heating element which is situated below the uppermost heating element and the adjacent heating elements which are situated beneath the heating element. The greater distance can lie between 20% and 90% of a width of the heating element. Otherwise, the heating elements can generally be at a very small distance, for example 3% to 10% of their width, in relation to one another.

In an advantageous refinement of the invention, the heating elements are in the form of heating conductors in track form. The tracks can all run parallel to one another, wherein the tracks run perpendicular to the longitudinal axis of the container at the same level and in each case only one single track or one single heating element runs at one level.

In a further refinement of the invention, heating elements of at least two different configurations can be provided in a heating circuit, wherein the heating elements differ in respect of electrical power, length, width and/or thickness. The heating elements advantageously differ only in respect of one of these abovementioned criteria and not in respect of the other abovementioned criteria, and the heating elements particularly advantageously differ in respect of their width and therefore their electrical resistance.

The heating elements are preferably in the form of heating conductors in track form and run parallel to one another. In this case, a plurality of heating conductors of a heating element or of a heating circuit can advantageously be actuated separately from one another and are connected or can be connected parallel to one another. This results in simple actuation.

As an alternative, it is possible for the heating elements to be in the form of heating conductors in track form and for all of the heating elements to run parallel to one another, but for a plurality of heating elements or heating conductors in the form of tracks to be interconnected electrically in series and, in particular, run in a meandering manner. In this case, at least two heating elements of a common heating circuit advantageously have a plurality of heating conductors in track form which run one into the other in a meandering manner.

In a development of this refinement, it is possible for an additional heating conductor contact to be provided on a heating element or on a heating circuit for electrically actuating the heating element or heating circuit or supplying power only to a portion of the heating element in the form of a partial heating element or only a partial heating circuit or only a portion of its heating conductors in track form. The additional heating conductor contact can be provided between one of two end heating conductor contacts of the heating element and, in the direction of one of the end heating conductor contacts, form the activated partial heating element.

A straight region along the longitudinal axis of the container advantageously has a strip shape and is free of heating elements and temperature sensors. The strip can have a width of 1% to 5% or 10% of the circumference of the container. By way of example, a weld seam by means of which a flat metal sheet is shaped to form the round container can run in the free region.

An evaporator according to the invention, which evaporator can be used in an electric cooking appliance of the kind mentioned in the introductory part or a steam cooking appliance, has at least one above-described heating device. A water supply line leads into the heating device or into the container, advantageously from the bottom through a base of the container, in particular centrally. The generated steam which is introduced into a cooking chamber of the appliance in which, for example, food is prepared, in particular heated, flows out of the container at the top. The heating device or the steam generation is controlled by means of a plurality of parameters, for example temperature measurement and steam measurement or moisture measurement in the cooking chamber.

During operation of a heating device of this kind, it is possible for the abovementioned temperature sensors of the first type and of the second type to be evaluated, in addition to the operating parameters of the heating circuits or heating elements themselves. In this way, it is possible to establish, for example, the events described in the text which follows. Firstly, increasing formation of limescale on an inner face of the container wall can be established. This is problematical since the transfer of heat from the heating elements on the outer face of the container to the liquid contained in the container is adversely affected. Therefore, both the degree of efficiency of the heating device or of the evaporator in respect of energy efficiency drops and also, under certain circumstances, it may no longer be possible for the required steam and temperature values to be reached. Furthermore, there is a risk of overheating, in particular on the outer face or on the heating elements, this possibly leading to damage. This should be prevented, and for this reason excessive amounts of limescale must not be formed over a large surface area. Furthermore, locally limited overheating on the inner face of the container wall can be detected. This can occur, for example, owing to an above-described increasing local formation of limescale, wherein this likewise constitutes an additional and generally serious and critical problem. In particular, the heating device can also be damaged or even destroyed in this case.

Furthermore, the drop in a filling level of water or liquid in the container below one of the heating circuits can be detected. If the filling level at the topmost heating circuit falls, the topmost heating circuit has to be entirely switched off under certain circumstances and at the same time liquid or water has to be refilled since otherwise operation of the topmost heating circuit is no longer possible. Furthermore, the drop in the filling level below a topmost heating element of the topmost heating circuit can be detected when a temperature sensor of the first type is arranged at this level. In this case, provision can be made, for this topmost heating element of the topmost heating circuit, for, as has been described above, the topmost heating element to be at a somewhat greater distance from the next heating element. The area load or area output can be lower, for example 3% to 20% or even 35% lower, for this topmost heating element than for the other heating element. The topmost heating element can be designed such that it is no longer necessary for there to be any water in the interior of the container at the level of the topmost heating element and nevertheless that a critical high temperature which could lead to damage does not occur in the region of the topmost heating element. For this reason, the topmost heating element is even arranged somewhat higher. The topmost heating element can also be somewhat wider, for example 3% to 20% or even 35% wider, than the other heating elements given the same length, as a result of which the lower output results in the case of the same current flow as through the other heating elements. In addition, in the case of a relatively large heated surface area, on account of the greater distance from the next heating element, the area output can be somewhat lower when the area output is considered in relation to the surface area of the container wall with the heating element surface area plus the clearance.

In a refinement of the invention, an electrical resistance of the heating circuits or of the heating elements of the heating circuits can be monitored and evaluated over time. In this way, the formation of limescale over a large surface area of the inner face of the container wall can be identified when, specifically, the time profile of the electrical resistance is compared with an evaluation or a time profile of the temperature sensors of the second type which constitute the surface-area temperature monitoring means. The formation of limescale over a large surface area in this way builds up slowly over a relatively long operating period, for example starting from an operating period of a few hours.

On the basis of the time profile of the formation of limescale during operation or over an operating period, the time remaining until a critical temperature or formation of limescale in respect of the thickness of the layer of limescale can be determined by way of a mathematical function. In this way, a kind of prewarning can, as it were, be output to a user in the form of a signal, so that the user knows when and how soon limescale has to be removed.

At the beginning of an operating cycle after the removal of limescale, any remaining limescale or so-called fur can be identified and taken into account. The remaining limescale is difficult to remove and has to be accepted, but can be included in the calculations.

In order to detect the values at the temperature sensors of the second type, the values at the temperature sensors of the second type can be detected each time an operating cycle begins and/or at specific time intervals during operation. The detection can take place, for example, every 10 minutes to 60 minutes. If the value at the temperature sensors increases by 0.1% to 3%, advantageously 0.5% to 2%, every 10 minutes to 60 minutes, advantageously every 20 minutes to 40 minutes, of operation, this is identified as a slowly increasing formation of limescale on the inner face of the container wall. A corresponding signal can then be emitted to a user, for example visually and/or audibly in a known manner. Very local overheating, irrespective of whatever triggered it, would generally cause a considerably more intense and more rapid increase which would then be a sign of local overheating.

In the event of a breakdown of the topmost heating circuit of the heating device or if an impermissible state had been established there and the topmost heating circuit then being switched off, the heating device can continue to be operated with the other heating circuits beneath the topmost heating circuit. Although the topmost heating circuit is not always the heating circuit with the greatest degree of limescale formation on the inner face, it is definitely the heating circuit which partially or fully boils-dry, that is to say no longer has any water at its level, the earliest. The heating circuit can be switched off in this case. Since the heating circuits which are situated beneath the topmost heating circuit may still have enough water at their level, the heating circuits can continue to be operated. In this case, corresponding information about this state is likewise output to a user, so that the user can intervene if appropriate, for example can initiate removal of limescale or repair.

Furthermore, provision can be made in the case of a temperature sensor of the first type establishing a high temperature at the topmost heating circuit, which is also arranged relatively far at the top on this heating circuit, for this to be considered to be a signal for refilling liquid into the container. The refilling operation can be performed automatically via a valve or the like at the water inlet into the container. The supplied quantity can be determined from the geometric conditions in the container region of the topmost heating circuit.

Furthermore, it is possible in one refinement of the method according to the invention to carry out filling level identification in the container by means of measuring the heating conductor resistances. For this purpose, firstly the temperature-dependent power consumption by the heating circuits and secondly the heating element resistances or the heating element temperatures are monitored since the heating element temperature is correlated with the electrical heating element resistance. An increase in the heating element temperature established in this way indicates a drop in filling level of the water in the container in the region of the corresponding heating element and therefore the corresponding heating circuit. This can be used to introduce more water and, respectively, to increase the filling level again.

Furthermore, it is possible to use an average heating element temperature for heating element monitoring. To this end, the heating element resistance values of all of the heating circuits lie at room temperature within a permissible tolerance range, that is to say relatively close to one another. In the cold state before the beginning of a first heating operation, the heating element resistance and the temperature of the liquid in the container present in the process are determined in a control means and stored. This applies for the heating elements of all of the heating circuits. The temperature coefficient of the heating elements is advantageously positive, and at room temperature this temperature coefficient of the heating elements can be stored in a memory in the control means.

As an alternative, the temperature coefficient in the event of initial heating can be determined with the aid of the temperature sensors of the first type. To this end, the resistance is measured at room temperature. Heating is then performed until the liquid is at a temperature of approximately 50° C. in the container, it being possible for this to be detected by means of the temperature sensors of the first type. Heating is then stopped and the process waits until the heating elements are the temperature of the liquid, this usually being the case after 2 seconds to 10 seconds. The electrical resistance at this temperature of 50° C. is therefore measured. Heating is then continued until the liquid in the container is at 75° C. The heating device is then switched off again and the process waits for a few seconds, until the heating elements are the temperature of the liquid, that is to say 75° C. The resistance of the heating elements can then be measured at this temperature of 75° C. This is also carried out when the liquid is boiling, that is to say at 100° C., in the same way in order to detect the resistance of the heating elements at 100° C. The characteristic variables of the electrical resistance, specifically the nominal resistance and the temperature coefficient at a nominal temperature of, for example, room temperature or of 25° C., are individually calculated for each heating circuit from the postulated linear profile of the electrical resistance of the heating elements using the measured value pairs of the resistance and the temperature of the liquid in the container.

With the aid of the initial value for the resistance of the heating elements at room temperature, the initial temperature of the liquid in the container and a determined typical value for the temperature coefficients or with the aid of the abovementioned characteristic variables of the electrical resistance and the temperature coefficients at room temperature or 25° C. for each heating circuit, the average actual heating element temperature can then be calculated later on the basis of the heating element resistance actually determined during operation in each case.

In general, the electrical resistance of the heating element together with its usual positive temperature coefficient can be used as a kind of resistance thermometer for the temperature of the heating element. In this case, a heating element itself would be a temperature sensor of a third type.

In order to operate the heating device or an evaporator or steam cooker having at least one heating device of this kind, advantageously also a plurality of heating devices of this kind, it is possible to permanently operate at a maximum power at the beginning until the boiling temperature of water is reached. This is known as boost mode. When the water in the at least one heating device is boiling or steam is generated in relatively large quantities, the heating circuits can be operated in a so-called evaporator mode in a pulsed manner by means of pulse width modulation. This is advantageous primarily when only a specific quantity of inflowing water has to be heated and evaporated or substantially only the evaporation temperature has to be maintained. A considerably lower power than the maximum power is required in this case.

Furthermore, for efficient use of energy, it is possible to operate only two of three heating circuits in a low-energy mode, and to do so permanently. With the above-described options for subdividing the heating elements of the heating circuits into heating circuits with partial powers, it is possible to once again more finely adjust a power setting. In a similar way, it is possible in an emergency mode, for example when one heating circuit breaks down or has to be switched off on account of an excessive temperature being established at the heating circuit, to continue heating with the other two heating circuits. In this case, the topmost heating circuit can be switched off in particular when energy is intended to be saved and the maximum quantity of steam is not required. Therefore, in this case, the filling level in the container can be reduced to approximately two thirds or the filling level can be high enough to reach the two lower heating circuits. In this case, the filling level should, if possible, be set such that it lies in the region of an operating heating circuit. Therefore, if a middle heating circuit of the three heating circuits has to be switched off, the lowermost and the uppermost heating circuit should be in operation. If the lowermost heating circuit has to be switched off, the upper two heating circuits should be in operation. In both cases, the filling level should be set up to approximately the upper level of the topmost heating circuit.

If, in contrast, the topmost heating circuit has to be switched off or the topmost heating circuit can be switched off on account of a lower quantity of steam being required, the filling level can and should be reduced to the level of the upper region of the middle heating circuit.

It is possible to store in a memory a profile of the voltage of the temperature sensor of the second type with respect to a thickness of a layer of limescale on the container, specifically firstly on the basis of determined measurement values. A thickness of the layer of limescale can then be determined on the basis of the stored measurement values using detected values of the voltage of the temperature sensor of the second type. Secondly, a thickness of the layer of limescale can be calculated using a formula which is derived from a stored curve, wherein, starting from a measured voltage of the temperature sensor of the second type, the thickness of the layer of limescale is precisely calculated using the formula.

These and further features can be gathered not only from the claims but also from the description and the drawings, wherein the individual features can be realized on their own in each case, or in various combinations, in an embodiment of the invention and in other fields and can constitute advantageous and independently patentable embodiments for which protection is claimed here. The subdivision of the application into individual sections and sub-headings does not restrict the general validity of what is said therein or therebeneath.

### BRIEF DESCRIPTION OF THE SEVERAL VIEWS OF THE DRAWINGS

Exemplary embodiments of the invention are schematically illustrated in the drawings and will be explained in greater detail in the text which follows. In the drawings:

FIG. 1 shows a plan view of a heating device according to the invention having three heating circuits and temperature sensors which are arranged one above the other;

FIG. 2 shows a plurality of evaporator modules separated from one another and in section, a heating device from FIG. 1 being installed in each of the said evaporator modules;

FIG. 3 shows the three evaporator modules from FIG. 2 in section and assembled to form an evaporator according to the invention;

FIG. 4 shows a steam cooker according to the invention having an evaporator according to FIG. 3 having a plurality of heating devices according to FIG. 1;

FIG. 5 shows a plan view of an unwound variant of a heating circuit with meandering partial heating circuits and heating elements of two different widths; and

FIG. 6 shows the relationship of the voltage across a temperature sensor of the second type with respect to a thickness of a layer of limescale on the inner face of the container.

### DETAILED DESCRIPTION

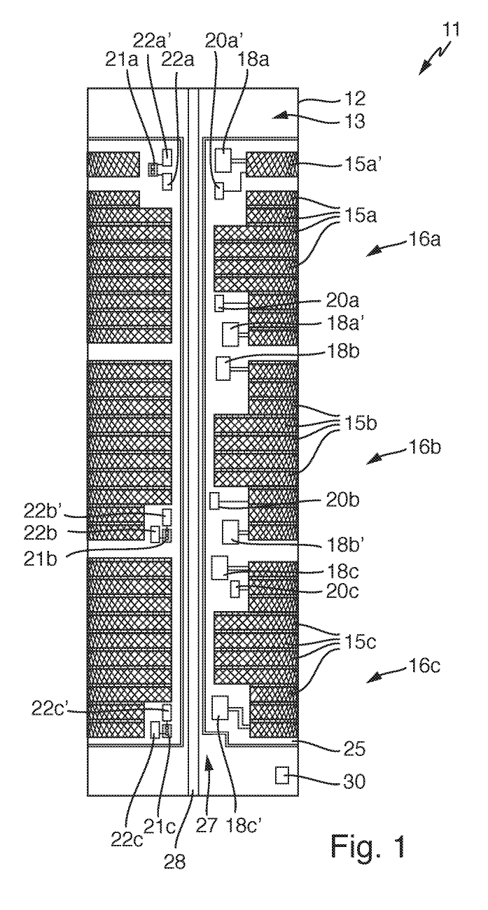

FIG. 1 shows an upright heating device 11 according to the invention which has a cylindrical tubular container 12 which is composed of metal. Strip-like heating elements 15 which, as illustrated, run along or around approximately 75% to 90% of the outer circumference of the container 12 are provided on an outer face 13 of the container 12. Upper heating elements 15a and the topmost heating element 15a′ form an upper heating circuit 16a. Middle heating elements 15b form a middle heating circuit 16b, and lower heating elements 15c form a lower heating circuit 16c. In this case, the middle heating elements 15b of the middle heating circuit 16b and the lower heating elements 15c of the lower heating circuit 16c and the heating circuits 16b and 16c are identical to one another. The upper heating circuit 16a is different in as much as, here, the topmost heating element 15a′ runs at a distance of approximately 60% of a width of the normal heating elements 15a above the said normal heating elements, that is to say is at an increased distance. In addition, the topmost heating element 15a′ is somewhat wider than the other heating elements 15a of the upper heating circuit 16a, as a result of which it both heats a greater surface area of the outer face 13 and has a lower resistance value and therefore has a low heating output or primarily a low area output.

Electrical contact is made with the heating circuits 16a to 16c by means of contact fields 18, specifically with the upper heating circuit 16a by means of the contact fields 18a and 18a′. The middle heating circuit 16b has the contact fields 18b and 18b′, and the lower heating circuit 16c has the contact fields 18c and 18c′. Furthermore, further additional contacts 20a′ and 20a to 20c are provided, specifically an additional contact 20b and, respectively, 20c for the middle heating circuit 16b and, respectively, the lower heating circuit 16c. The upper heating circuit 16a has an additional contact 20a with an arrangement similar to in the middle heating circuit 16b. A further additional contact 20a′ is provided on the topmost heating element 15a′.

On the basis of FIG. 1, it is also easily possible to envisage the abovementioned modification that, for example, the topmost heating circuit 16a is vertically divided into an upper partial heating circuit with 4 or 5 of the heating elements 15a and into a lower partial heating circuit with 5 or 6 of the heating elements 15a. This then corresponds, as it were, to the arrangement of the heating circuits 16a and 16b if the heating circuits were considered to be partial heating circuits. To this end, the distances do not have to be changed, it is only necessary to divide the actuation between several contact fields 18, but this presents no problems. Under certain circumstances, the middle heating circuit 16b can also be divided in this way. For example, a more finely subdivided output division than is possible only by switching off entire heating circuits is possible by virtue of partial outputs.

In the left-hand region, SMD temperature sensors 21a to 21c, which form the temperature sensors of the first type and have been described in the introductory part, are provided on the heating circuits 16a to 16c. Two temperature sensor contact fields 22a and 22a′, 22b and 22b′ and 22c and 22c′ are provided for each SMD temperature sensor 21a to 21c. The temperature sensor contact fields are fully electrically disconnected from the heating circuits 16a to 16c. In this case, the associated SMD temperature sensor 21a is arranged in the topmost region or level with the topmost heating element 15a′ with respect to the upper heating circuit 16a. In the other two heating circuits 16b and 16c, the SMD temperature sensors are arranged in the lowermost region.

An above-described dielectric insulation layer is fitted on the outer face 13 of the container 12, specifically directly on the metallic outer face. The dielectric insulation layer forms a substantial portion of the temperature sensors of the second type, as has been described in the introductory part. It is clear that a strip region 27 is provided in the middle of the container 12 along the longitudinal axis of the said container, the dielectric insulation layer 25 being cut out in the strip region. A weld seam 28 runs in the strip region 27 since the tubular container 12 is formed from a metal sheet and the edges which bear one against the other are also welded to one another. The insulation layer 25 is at a certain distance from the lower edge and from the upper edge of the container 12, for example between 5% and 15% of the length of the container 12. Therefore, the insulation layer runs substantially only below the heating elements 15 or the heating circuits 16.

As has been explained in the introductory part, it is either possible to produce the entire dielectric insulation layer 25 homogeneously or from the same material or glass. However, as an alternative, two differently conductive materials or glasses can be used. The materials can even be fitted one over the other and/or one on the other, wherein contact has to be made with each of the said materials individually.

A so-called outer-face contact 30 is fitted at the bottom of the container 12, specifically directly onto the metallic container 12 or the outer face 13 of the metallic container. Since the dielectric insulation layer 25 is fitted on this outer face 13 and, in turn, the heating elements 15 are fitted on the dielectric insulation layer, the design of the temperature sensors of the second type can be explained in accordance with the above functional description and the functions according to the above-mentioned document DE 102013200277 A1. The insulation layer 25 forms, as it were, a surface-area, temperature-dependent electrical resistor which, at temperatures of up to approximately 80° C., wherein the temperature can be adjusted, has a very high electrical resistance and therefore no current flows across the insulation layer. A current of this kind can be detected firstly at the outer-face contact 30 and secondly, in order to differentiate between quasi different regions, by means of the additional contacts 20a′ and 20a to 20c in the region of the topmost heating element 15a′ or the three heating circuits 16a to 16c. Here, the heating elements can then serve as an electrode. If the temperature also continues to rise only in a small region and reaches, for example, 100° C., the electrical resistance drops. At temperatures of, for example, 150° C., the resistance in this small region can have dropped to such an extent that, although the electrical insulation properties are sufficient to operate the heating circuits 16a to 16c without problems on the metallic container 12, a flowing current or leakage current which can flow in the region of these temperatures can, however, already be reliably detected. It is not possible to precisely determine a locally overheated small region of this kind at a precise point but nevertheless in the region in which the heating elements 15a′ and, respectively, heating circuits 16a to 16c, with which an additional contact 20a′ and, respectively, 20a to 20c makes contact, run.

High temperatures of this kind, which clearly lie above 100° C., can actually occur during operation of the heating device 11 or of an evaporator which is provided with the heating device and during evaporation of water only when firstly there is no longer any water or secondly the reduction in heat is no longer enough due to the severe formation of limescale at one point, with the result that overheating occurs. In the first case in which there is generally no longer any water in a region of this kind, a countercheck can be made with the state of the respective SMD temperature sensor 21a to 21c, primarily the topmost temperature sensor 21a. If the SMD temperature sensor also establishes a temperature of above 100° C., the filling level of the water has obviously dropped. If, however, the topmost SMD temperature sensor 21a still establishes a temperature of at most 100° C., there is a clearly higher temperature, which is established by a temperature sensor of the second type together with the insulation layer 25 and the additional contacts 20, at a point of excessive formation of limescale on the inner face of the container 12. Depending on the extent of the surface-area region and on the extent of the excess temperature, the corresponding heating circuit 16 can continue to be operated or else can be switched off. In each case, a signal can be sent to an operator in the manner described in the introductory part in order to notify the operator that limescale has to be removed from the heating device 11 or the evaporator.

A statement can be made about the formation of limescale on the heating elements or heating circuits by evaluating the two types of temperature sensors. Therefore, it is possible to establish whether the formation of limescale on the heating elements is uniform, that is to say the limescale is distributed geometrically approximately equally. If the formation of limescale on the heating elements is not uniform, uniform formation of limescale can be induced by switching the heating elements differently during operation, that is to say more powerfully where the formation of limescale was not so severe. The time remaining until it is next necessary for the user or a service engineer to remove limescale can be displayed during operation of the appliance.

The topmost heating element 15a′ could also extend, as it were, over two or more tracks in order to identify the filling level in this way or using the temperature sensor of the second type by means of the additional contact 20a′ which in this case runs over the topmost tracks of the heating element 15a′. The filling level can even be identified over the entire upper heating element 15. To this end, the entire surface area of the upper heating element would have to be increased in size and an overall power of, for example, 3 kW would have to be maintained.

Introduction of water after partial boiling-dry can be identified by the SMD temperature sensor 21a of the first heating circuit 16a. If the level of the freshly introduced water reaches, specifically, the position of the SMD temperature sensor 21a, this can be identified by the resulting drop in temperature. It is feasible for the quantity of introduced water to be determined by means of an existing delta T with a further temperature sensor in the inlet. The introduction of fresh water from below during the heating/evaporator mode can be identified by the temperature sensor 21c of the lower heating circuit 16c. The mixture of heated and freshly supplied water has, specifically, a lower temperature, and a drop in temperature at the temperature sensor 21c can therefore be determined, wherein, as a result of the introduced water being guided in a corresponding manner, the water can flow past the container wall region of the temperature sensor 21c in order to readily identify a drop in temperature at the temperature sensor 21c. Correct functioning of a fresh-water supply means can be monitored in this way.

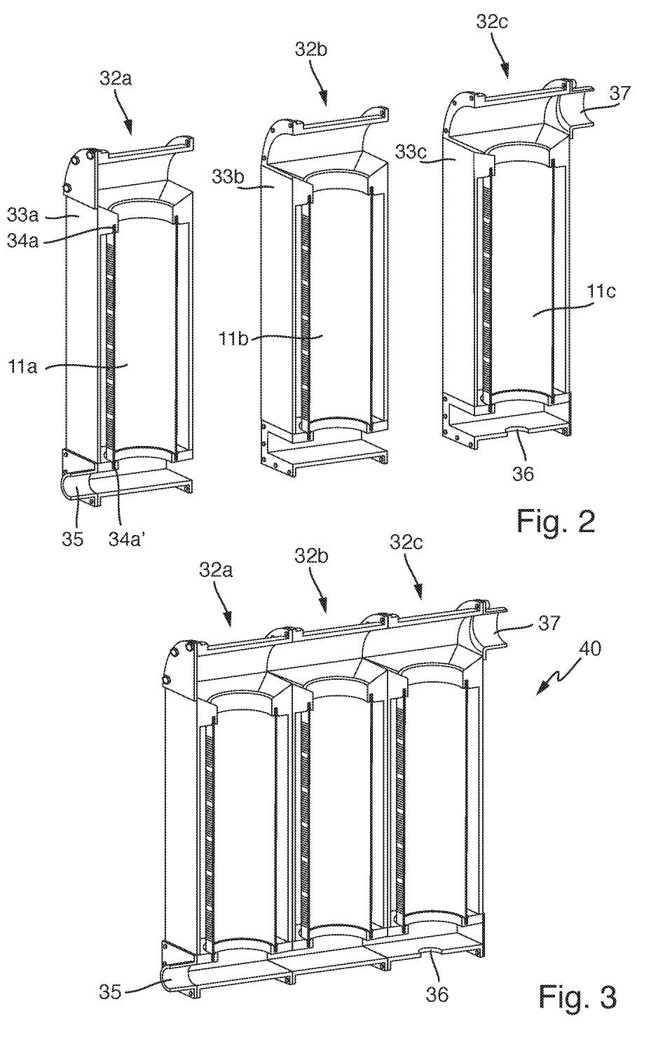

FIG. 2 shows three individual evaporator modules 32a to 32c in section with a cut surface at the visible front face. Each evaporator module 32a to 32c has a module housing 33a to 33c. Heating devices 11a to 11c according to FIG. 1 are inserted into each of the evaporator modules 32a to 32c by means of seals 34a to 34c and 34a′ to 34c′. A water inlet 35 on the far left runs beneath the heating devices 11a to 11c, through the module housings 33a to 33c, to a water outlet 36 on the far right. At the top, the steam which has collected in all of the evaporator modules 32a to 32c can be discharged at a steam outlet 37.

FIG. 3 shows an evaporator 40 which comprises the three assembled evaporator modules 32a to 32c of FIG. 2. Therefore, the evaporator has three heating devices 11a to 11c and is therefore designed for a high total evaporator output.

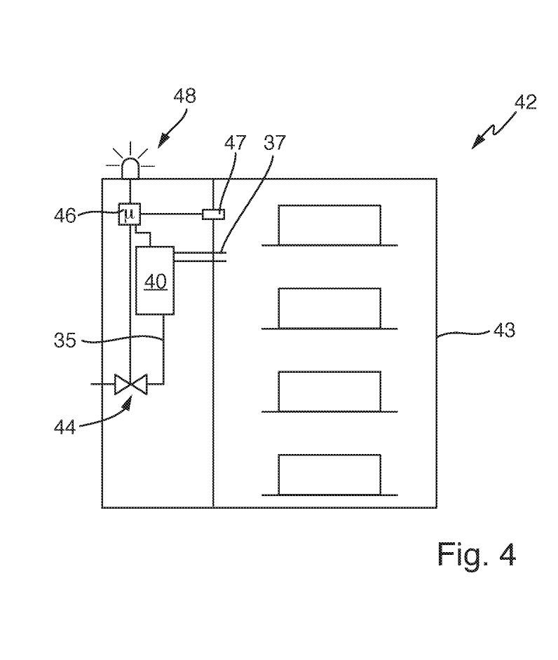

FIG. 4 shows a steam cooker 42 according to the invention having a cooking chamber 43 of conventional design, for example of cabinet size. The evaporator 40 of FIG. 3 is arranged in the left-hand region of the steam cooker 42, illustrated schematically here. A precisely determined quantity of fresh water is supplied at the water inlet 35 via an inlet valve 44. Steam which is produced is let out and introduced into the cooking chamber 43 at the steam outlet 37.

The evaporator 40 has a control means 46 which can also be the control means of the entire steam cooker 42, or else can be connected to a control means of the entire steam cooker. The control means 46 firstly controls the inlet valve 44. Furthermore, the control means is connected to the evaporator 40 or to all of the connections or contact fields and additional contacts and to the outer-face contact of the heating device 11 of FIG. 1. Furthermore, the control means 46 has a temperature sensor 47 in the cooking chamber 43, wherein a plurality of temperature sensors can also be provided. In addition, steam sensors which can detect the presence of steam in the cooking chamber 43 and also the quantity of the steam and, for example, also the degree of saturation of the steam, can also be provided.

In addition, the control means 46 is provided with a signaling lamp 48 on the steam cooker 42 as a possible basic way of signaling something to a user. As an alternative to a very simple signaling lamp 48 of this kind, a display can be provided on the steam cooker 42, for example even a touch display for outputting information and operating states and for inputting instructions.

Temperature detection by means of the temperature sensors of the second type or monitoring the temperature of the heating elements can be performed with a low voltage or a low protective voltage and with AC voltage or DC voltage, for example less than 50 V or even less than 25 V in the case of an AC voltage and less than 120 V or even less than 60 V in the case of a DC voltage.

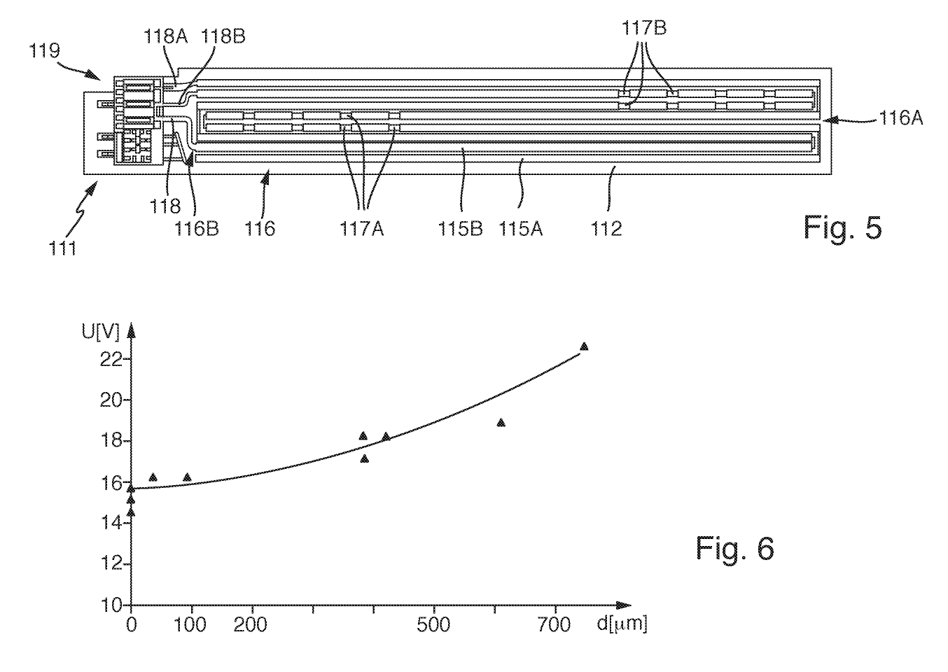

FIG. 5 shows a plan view of a detail of a further modification of a heating device 111. A heating circuit 116 is fitted on a container 112 as a support. Two types of heating elements are provided here, specifically firstly heating elements 115A and secondly heating elements 115B. In this case, the heating elements 115B are noticeably wider than the heating elements 115A, for example 20% wider. The heating elements 115A form a partial heating circuit 116A, and the heating elements 115B form a partial heating circuit 116B. The two partial heating circuits 116A and 116B run in a meandering manner one in the other, so that they ultimately heat the same area when they are operated individually, in the common mode in any case. Therefore, the heating output of the heating circuit 116 can inherently be divided differently as it were. Both partial heating circuits 116A and 116B are operated for the maximum desired heating output. Only one of the two partial heating circuits 116 is operated for the minimum desired heating output, specifically the partial heating circuit 116A with the narrower heating elements or conductors which have a higher resistance, are connected electrically in series and therefore generate less heating output. The partial heating circuit 116B which generates a greater heating output is operated for a desired heating output which lies between the maximum desired heating output and the minimum desired heating output. The partial heating circuits 116A and 116B can, as described, be operated in parallel or separately, but also in series. Therefore, it is possible to divide the heating output into 100%, barely 60%, somewhat greater than 40% and 0%.

Both partial heating circuits 116A and 116B have the same length and, in the heating circuit 116, four longitudinal sections in each case. Both partial heating circuits 116A and 116B also have interruptions 117A and 117B through contact bridges at two longitudinal sections, which are situated next to one another, in a known manner. Therefore, the heating output can be locally reduced to a certain extent.

Electrical contact is made with the partial heating circuits 116A and 116B by means of the individual contact fields 118A and 118B and a common contact field 118. A plug connection 119 which is fitted on the contact fields 118 or on the container 112, advantageously according to EP 1152639 A2, is also schematically shown.

Therefore, this exemplary embodiment of FIG. 5 shows how both the heating elements 115A and the heating elements 115B are in each case connected in series, whereas they are each connected in parallel in the exemplary embodiment of FIG. 1. The figure also shows the meandering form which is advantageous and, under certain circumstances, even necessary in order to accommodate the desired length without overlapping. Finally, FIG. 5 further shows that differently designed heating elements, which have different output properties in respect of total output and/or area output, can be provided for each partial heating circuit. As a result, it is possible to even more finely adjust the heating output generated overall for each heating circuit, which would not be possible with individual heating elements of identical design. Here, an abovementioned additional heating conductor contact could also be provided, for example, at the point above the common contact field 118 on the heating element 115B or on the partial heating circuit 116B approximately in its centre. Therefore, division into two partial heating elements or partial heating circuits which can be actuated independently of one another by means of the contact fields 118B and 118 as abovementioned end heating conductor contacts and even the additional heating conductor contact is once again possible. This can be used for further finer subdivision of a heating output by virtue of the abovementioned separate, parallel or serial operation.

FIG. 6 shows the relationship of the voltage across a temperature sensor of the second type by means of the dielectric insulation layer, which is described in connection with FIG. 1, on the Y axis with respect to a thickness of a layer of limescale on the inner face of the container 12 on the X axis. From the individual values which are illustrated by triangular symbols, an approximate function can be specified given specific thicknesses of the layer of limescale, where:

Y=(9 E−06)X²+0.002 X+15.357; R²=0.9162.

Measured values corresponding to the triangular symbols can be stored either in a table in a memory, advantageously continuous values over a large range of the possible layer thickness, and then a prespecified thickness of the layer of limescale can be determined from the measured values on the basis of a measured voltage across a temperature sensor of the second type. The thickness of the layer of limescale given a specific voltage across a temperature sensor of the second type is advantageously directly calculated using the abovementioned function. Handling instructions for operation of the heating device can then be derived from the result of the calculation depending on operation, for example with a request to an operator to remove limescale soon, to remove limescale immediately or to reduce the heating output which can be generated.

1. A heating device for heating liquids or for evaporating liquids for an electric cooking appliance, comprising:
a container for said liquid, said container comprises a height which is greater than its width;
heating elements arranged in a manner distributed over a surface area, on an outer face of a lateral container wall;
at least three separate or separately operable heating circuits on said outer face, wherein each said heating circuit has at least one said heating element;
a plurality of temperature sensors on said outer face; and
the plurality of said temperature sensors is provided in a form of at least two types, wherein at least one temperature sensor of a first type is a discrete component which is mounted on said outer face of said container wall, and wherein at least one said temperature sensor of a second type is fitted in a form of a surface-area coating to said outer face of said container wall.

2. The heating device according to claim 1, wherein said first type of temperature sensors are in a form of SMD components.

3. The heating device according to claim 1, wherein one single temperature sensor of said first type is provided for each said heating circuit, wherein said temperature sensor of said first type is provided in a region of and along a longitudinal axis of said container vertically level with said respective heating circuit.

4. The heating device according to claim 1, wherein a distance between a temperature sensor of said first type and a closest heating element lies between twice and twenty times a thickness of said container wall.

5. The heating device according to claim 1, wherein:
for said temperature sensor of said second type, a dielectric insulation layer is fitted on said outer face of said container wall and said heating elements of a heating circuit are fitted over said dielectric insulation layer;
a covering layer is provided over said heating elements;
a measurement electrode is provided on said covering layer; and
a measuring device is connected both to said measurement electrode and also to said heating elements, and is designed to detect a current flow between said heating elements and said measurement electrode for evaluation as a measure of a change in temperature at said heating circuit or at said container in a region close to said heating circuit.

6. The heating device according to claim 5, wherein said insulation layer is fitted directly on said outer face of said container wall and covers a large portion of said entire surface of said outer face of said container wall.

7. The heating device according to claim 6, wherein said insulation layer comprises a single continuous insulation layer beneath all of said heating elements.

8. The heating device according to claim 5, wherein a further additional insulation layer is fitted on said insulation layer, wherein said heating elements are fitted on said additional insulation layer.

9. The heating device according to claim 5, wherein said measurement electrode and said heating elements run in different layers with at least one of said insulation layer and a covering layer therebetween.

10. The heating device according to claim 9, wherein said measurement electrode is formed over a surface area and substantially covers said heating elements.

11. The heating device according to claim 1, wherein at least one temperature sensor of said second type is provided for each of said heating circuits, wherein said temperature sensor of said second type covers at least 50% of a surface area of said heating elements of said associated heating circuit.

12. The heating device according to claim 1, wherein, in a vertical extent of said container, each said heating circuit is at a distance from said other heating circuits and each said heating circuit covers a vertical region of said outer face of said container wall.

13. The heating device according to claim 12, wherein at least two lowermost vertical regions are of equal height and an uppermost vertical region is at most 20% higher.

14. The heating device according to claim 1, wherein two lowermost of said heating circuits are of identical design with respect to their heating elements, also with respect to an arrangement of at least one of said temperature sensor of said first type and of said second type on said respective heating circuit.

15. The heating device according to claim 1, wherein, in two lowermost heating circuits, said temperature sensor of said first type is arranged in said lower region of said heating circuits, wherein said temperature sensor of said first type of an uppermost heating circuit is arranged in an upper vertical region of said heating circuit.

16. The heating device according to claim 1, wherein:
a distance between an uppermost heating element of an uppermost heating circuit and an adjacent heating element which is situated below it is greater than a distance between said adjacent heating element, which is situated below said uppermost heating element, and a next heating element and said other heating elements of said heating circuit which are situated beneath said heating element in relation to one another; and
said distance corresponds to between 20% and 90% of a width of said heating element.

17. The heating device according to claim 1, wherein said heating elements are in a form of heating conductors in track form, wherein said tracks all run parallel to one another and perpendicular to a longitudinal axis of said container at the same level.

18. The heating device according to claim 1, wherein:
heating elements of at least two different configurations are provided in one said heating circuit; and
said heating elements differ in respect of electrical power, length, width or thickness.

19. The heating device according to claim 18, wherein said heating elements differ only in respect of one of these abovementioned criteria and not in respect of said other abovementioned criteria, wherein said two heating elements of at least two different configurations differ in respect of their width.

20. The heating device according to claim 1, wherein:
said heating elements are in a form of heating conductors in track form and run parallel to one another; and
a plurality of said heating elements form a heating circuit or partial heating circuits which can be actuated separately from one another and are connected parallel to one another.

21. The heating device according to claim 1, wherein:
said heating elements are in the form of heating conductors in track form and run parallel to one another, wherein a plurality of heating elements in a form of tracks are interconnected in series and run in a meandering manner.

22. The heating device according to claim 21, wherein two said heating elements of a common heating circuit form partial heating circuits and have a plurality of heating conductors in track form which run one into the other in a meandering manner.

23. The heating device according to claim 1, wherein an additional heating conductor contact is provided on one said heating element for electrically actuating said heating element or supplying power only to a portion of said heating element in a form of a partial heating circuit between one of two end heating conductor contacts of said heating element and said additional heating conductor contact.

24. An evaporator for an electric cooking appliance having a heating device for heating and evaporating water, wherein said heating device is formed according to claim 1.

25. A method for operating a heating device according to claim 1, wherein said temperature sensors of said first type and of said second type are evaluated in order to establish an event from the following group:
increasing formation of limescale on an inner face of said container wall;
locally limited overheating on said inner face of said container wall;
drop in a filling level of water in said container below a topmost heating circuit; and
reduction in said filling level of water in said container below a topmost heating element of said topmost heating circuit.

26. The method according to claim 25, wherein an electrical resistance of said heating circuits is monitored and evaluated over time in order to identify a formation of limescale over a large surface area of said inner face of said container wall, wherein said evaluation is compared with an evaluation of said temperature sensors of said second type in a form of surface-area temperature detection.

27. The method according to claim 25, wherein values at said temperature sensors of said second type are detected each time an operating cycle begins or at specific time intervals during operation.

28. The method according to claim 27, wherein, in an event of an increase by 0.1% to 3% every 10 minutes to 60 minutes of operation, said formation of limescale on said inner face of said container wall is identified and a corresponding signal is emitted to a user.

29. The method according to claim 25, wherein, in an event of a breakdown of said topmost heating circuit of said heating device or in an event of an impermissible state being established in said topmost heating circuit together with said topmost heating circuit subsequently being switched off, said heating device continues to be operated with said other heating circuits, wherein corresponding information about this state is output to a user.

30. The method according to claim 25, wherein:
a profile of a voltage of said temperature sensor of said second type with respect to a thickness of a layer of limescale on said container is stored in a memory or is calculated using a formula which is derived from a stored curve; and
starting from a measured voltage of said temperature sensor of said second type, said thickness of a layer of limescale on said container is calculated using said formula.
